(19) United States
(12) Patent Application Publication
(10) Pub. No.: US 2008/0039750 A1
(43) Pub. Date: Feb. 14, 2008

(54) Dry hydro-massage recliner

(76) Inventor: Waleed Mustafa Mahmoud, Manama (BH)

Correspondence Address: Waleed M. Mahmoud, P.O.Box: 45 FOSROC, Manama, omitted

(21) Appl. No.: 11/500,214

(22) Filed: Aug. 8, 2006

(51) Int. Cl. A61H 1/00

(52) U.S. Cl. 601/55

(57) ABSTRACT

A dry hydro-massage apparatus characterized by a substantially bent backwardly inclined sitting position, a generally loosely held seating sheet, and utilizes a reclining chair mechanism to facilitate for the user the process of assuming the inclined sitting position on the chair. The dry hydro-massage apparatus involves applying a jetting stream of water on the underside of the flexible seating sheet, translating to soothing and massaging stresses on the user's opposing body parts, whilst the said sheet obstructs the water from wetting the user. The seating position is raised from the floor so that the water jetting activity can be watched through see-through windows by the public.

### BACKGROUND OF THE INVENTION

The invention relates to a massage apparatus that extends to the user a soothing massaging effect created by impacting stresses on the user's backside created by a jetting stream of water. The water is ejected on the underside of the sheet that supports the user's weight and which also serves to obstruct the water from wetting the user. The novelty of the present invention is mainly established by incorporating in a dry hydro-massage apparatus a new sitting position, a new profiled seating surface, and a new seating arrangement wherein a person can initially sit in a normal way on a substantially loosely held sheet, and then the sitting position gets reclined or unfolded to provide a more relaxing bent backwardly inclined position, therefore enhancing the muscle relief during the massage course.

### DISCUSSION OF PRIOR ART

Although prior art described in U.S. Pat. No. 5,827,206 discusses a dry hydro-massage apparatus comprising a chair body, said patent does not set forth an independent claim for the singular condition of the use of a chair in a dry hydro-massage apparatus, but instead continues to describe further accessories and design details of the chair as having an elongated opening centrally located in its back support, surrounded at the top and sides by back support surfaces. The described apparatus in the said patent only offers the user a massaging effect on the spinal parts of the user' back; moreover the described seat back is not characterized by being substantially backwardly bent, and therefore the majority of the user's weight is not evenly distributed along the seating background, consequently the user is not substantially relieved of the majority of his upper body's weight.

Another prior art described in U.S. Pat. No. 4,908,016 discusses a dry hydro-massage apparatus that requires the user to lay on his chest on a flat surface, the person then receives a massaging water jet on his backside, whilst covered with a flexible sheet to avoid getting wet. The said patent claims the method of covering substantially the entire body of the user with a flexible sheet, said sheet serves only to prevent the user from getting wet. This apparatus encloses the user in a box-type confined area between a bed, a covering sheet, and a lid, and requires the user to lay on the chest, such position when in public area is embarrassing to many people and totally rejected in many cultures.

Another prior art described in U.S. Pat. No. 6,428,466 discusses an arrangement similar to the one described above, but describes in a consolidated claim detailed description of the various components of the confining cabinet, hence patenting the described sophisticated combination as a whole.

Another prior art described in U.S. Pat. No. 4,976,256 discusses in one of its claims a bed structure with a generally horizontal lying position, having a generally stretched weight bearing surface, wherein the lower chamber is filled with air to enable the user to remain in generally flat position. This apparatus provides an unstable surface similar to that of a water mattress, and again requires the user to lay on the back on a bed, an uneasy situation for many people.

In all prior arts, the ability of spectators and passers-by to watch the water jetting activity which is both entertaining and curiosity stimulating, was only limited to those machines that involved the user lying on the chest, as this position would geometrically bring the water jetting apparatus to a location that can be conveniently watched by the public, this though was not the case for those machines that involved the user lying on the back as the water jetting mechanism would geometrically be closer to the ground, making it unnecessary to install see-through sides, and consequently was not thought of prior to the present invention. This is dealt with in the present invention by raising the whole arrangement to a higher level and thus bringing the water jetting activity to a convenient viewing level for the spectators. The present invention provides a stairs apparatus for the user to ascend to the raised position.

No other dry hydro-massage apparatus known to the applicant of the present invention offers a dry water massage course to the user whilst sitting in a substantially bent backwardly inclined position on a loosely held seating sheet.

### SUMMARY OF THE INVENTION

The general scope of this invention is a dry hydro-massage apparatus offering the user a new more relaxing substantially bent backwardly inclined position combined with a seating background made of a loosely held sheet that allows the massaging stresses to cover wider area of the user's backside, while the seating sheet also serves to obstruct the water from wetting the user.

It is an object of the invention to facilitate for the user, in a dry hydro-massage apparatus, the process of assuming an otherwise difficult to assume sitting position which is substantially backwardly inclined by enabling the user to initially sit in a normal way and then recline to the final substantially inclined position.

The said substantially inclined sitting position offers the user a more acceptable alternative to the full horizontal supine position required in many other dry hydro-massage machines.

It is also an object of this invention to offer the user the option of full privacy whilst having the massage course. This privacy definitely contributes to a great deal to the effect of the massaging therapy.

The invention also introduces the new concept of a substantially raised sitting position making it possible for spectators and passers-by to watch the thrilling water gushing activity, adding to the entertainment and stimulating curiosity.

### BREIF DESCRIPTION OF THE DRAWINGS

FIG. 1 is a schematic diagram of the arrangement of the various components of the dry massage apparatus

FIG. 2 is a sketch showing the user in the normal sitting position

FIG. 3 shows the user in the substantially inclined sitting position

FIG. 4 is a schematic diagram of the weight bearing seating apparatus

FIG. 5 shows where the seating apparatus is located in relation to the full embodiment

FIG. 6 is a schematic diagram of the water jetting apparatus with nozzles

FIG. 7 shows the mechanism of pulling the water jetting apparatus in one direction by a motor-driven slow rotating wheel and a string attachment.

FIG. 8 shows the releasing mechanism that allows motion in the reverse direction by the force of gravity.

FIG. 9 shows a preferred embodiment of the dry hydro-massage apparatus with the see-through windows, external handrails and set of stairs.

FIG. 10 shows the full embodiment when the rotation axis is chosen at a point on the Embodiment.

FIG. 11 shows a perspective view of the main components of the machine.

### DETAILED DESCRIPTION OF THE PREFERRED EMBODIMENT

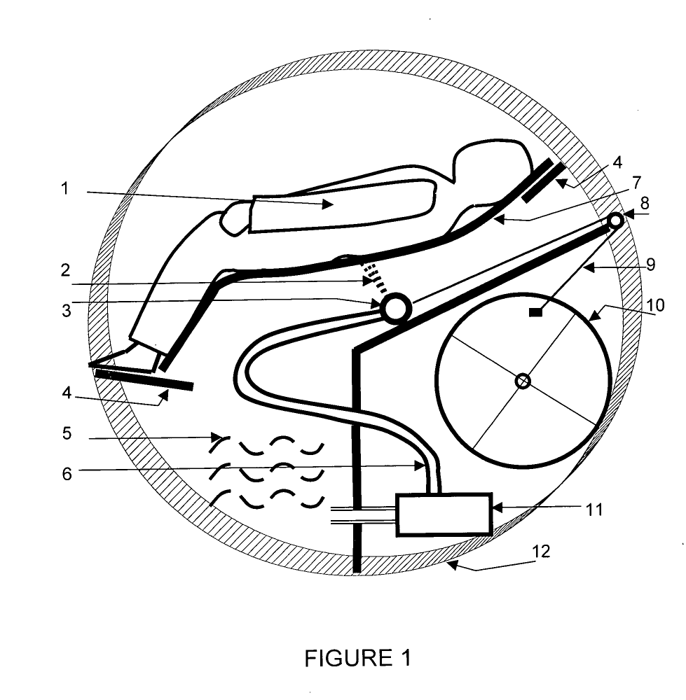

FIG. 1 shows the preferred embodiment, which comprises two main round frames 12 made of preferably aluminum tubes having approximately a diameter of 2.0 metre. The area inside the frame making the side of the frame is made of preferably aluminum plate and has a see-through portion in it made preferably of plastic material. The two frames, approximately 70 cm apart, enclose between them in the upper portion a reclining seat 7 made of a loosely held flexible sheet, The flexible sheet can be made of one or more layers of any suitable material including but not limited to PVC, Plastic, or Polyethylene.

The reclining seat is mounted in the upper portion of the embodiment on aluminum ledges 4. The lower portion of the embodiment comprises a water jetting apparatus 3 that slides in a restrained motion, an open-top water reservoir 5, a slow rotating wheel 10, and a water pump 11. The water pump is connected directly to the water chamber at the intake inlet, and connected at the outlet to the water jetting apparatus by a flexible water pipe 6. A string 9 is attached at one end to the water jetting apparatus, and at the other end to the wheel. The string passes through a pulley 8 when changing direction.

The pump will drive the water with sufficient pressure through the flexible pipe to the water jet apparatus. Jetting water 2 will then be ejected through nozzles in the water jetting apparatus and impact stresses on the underside of the seat sheet. The water will then fall by gravity back to the water chamber through an opening or a perforated preferably aluminum plate, and so on.

The slow rotating wheel will pull the attached string as it rotates resulting in a pulling and releasing action on the string, said action will be transferred to the water jet apparatus causing it to slide in alternate directions. This motion will distribute the stresses created by the stream of water along the backside of the user's body.

The electric motor and reducing gear apparatus that drive the rotating wheel are not shown in this drawing to avoid crowding the view.

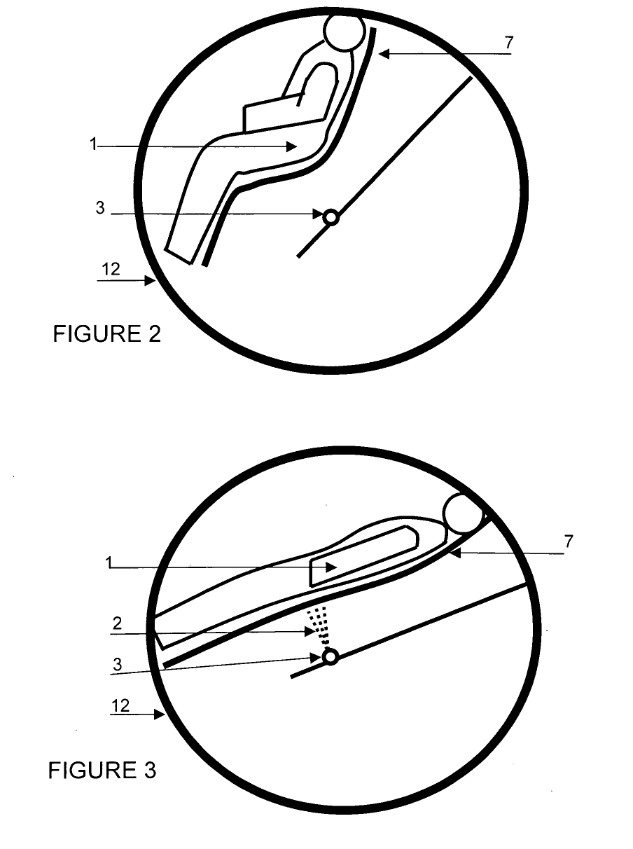

FIG. 2 shows the initial sitting position of the user before that sitting position gets reclined, and before the water jetting operation is started.

FIG. 3 shows the final sitting position of the user, wherein the user becomes in a substantially bent backwardly inclined position during the massage course. The reclining mechanism in FIG. 3 relies on the full rotation of all the embodiment of the dry hydro-massage apparatus, and whereas this is just a preferred method, it is not the only method possible in this invention, as this could be achieved by rotating or unfolding parts or all of the seating apparatus or the embodiment of the machine.

FIG. 4 shows the seating apparatus comprising a substantially loosely held sheet attached to a frame body. This frame body is made of one or more interconnected portions to allow unfolding the seat to a substantially bent backwardly inclined position. The most simple and preferred arrangement however is to have the seat frame body made of one portion mounted on the embodiment in a way that will offer a normal sitting position before it gets rotated with the whole embodiment to arrive to the substantially inclined position.

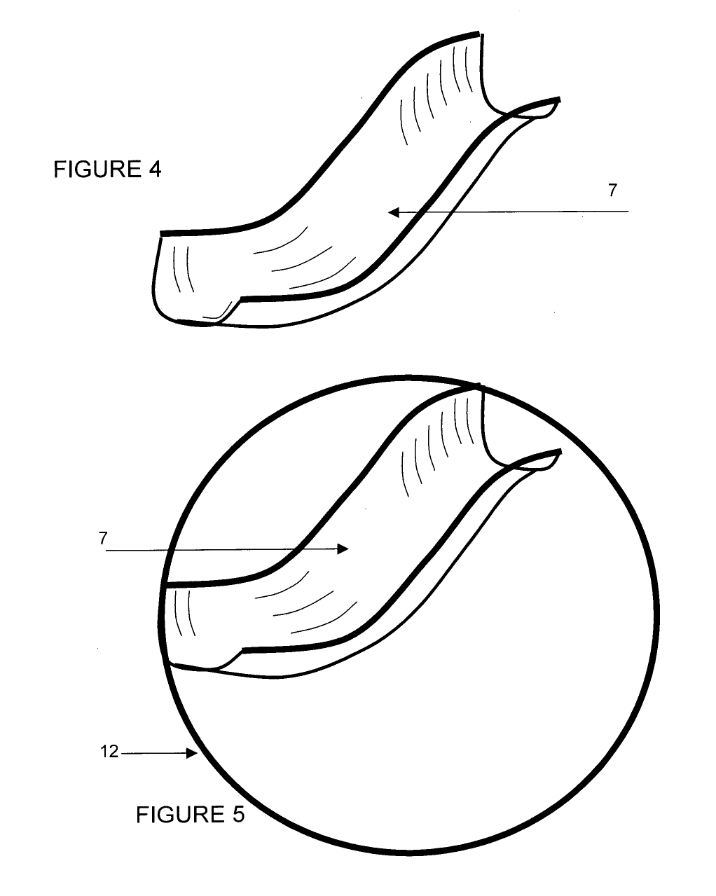

FIG. 5 shows the preferred location of the mounting of the said seating apparatus between the two main frames 12 which have preferably aluminum sides.

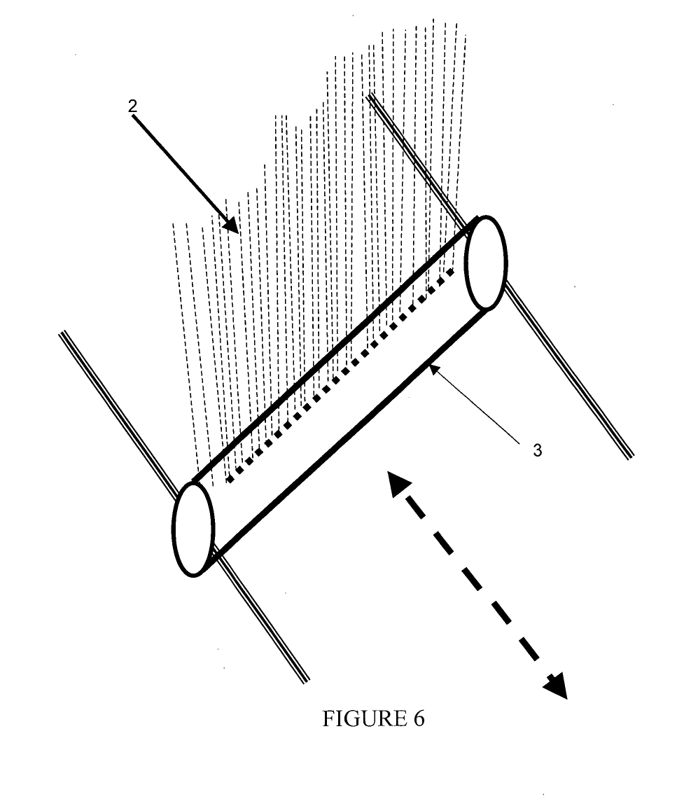

FIG. 6 shows a preferred arrangement of the water jetting apparatus, wherein it preferably comprises an aluminum tube having nozzles on its surface, and slides in a restrained manner on one or more aluminum rails. The length of the rails depends on the intended breadth of intended massage, but is preferred to extend from the buttocks of the user to the shoulders.

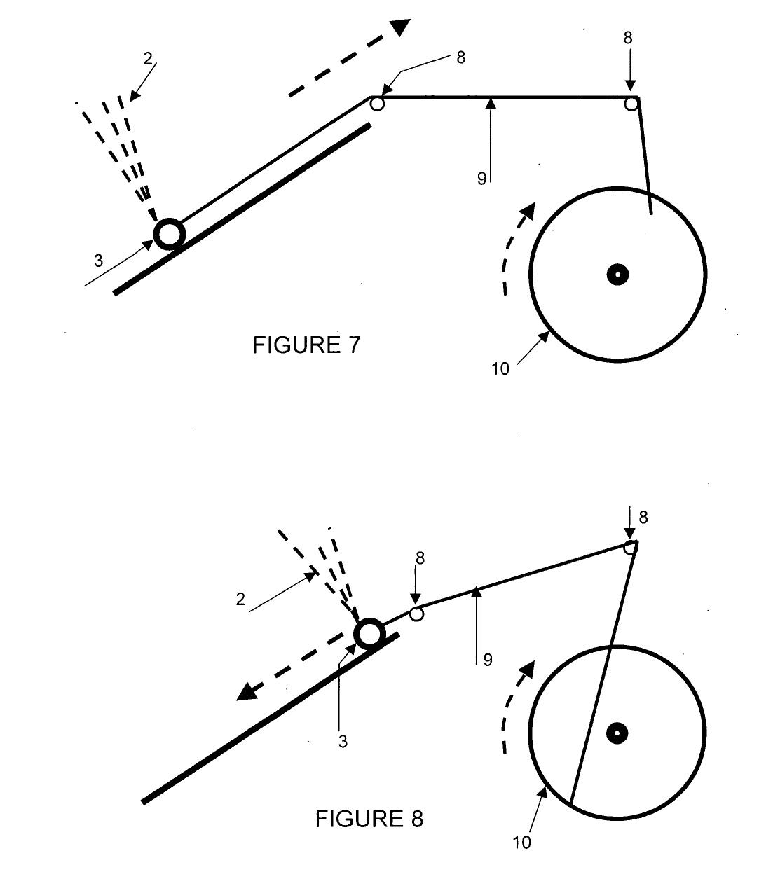

FIG. 7 and FIG. 8 show in more clarity the mechanism of pulling and releasing the said string 9 by the rotating wheel 10, and how this motion is transferred through the pulley 8 to the water jetting apparatus 3. The machine could have more than one pulley depending on its final design, wherein the pulleys could be located in any convenient place to achieve the intended purpose. The diameter of the wheel and the point where the string is attached will determine the breadth of coverage of the water jet apparatus, and since it is expected that different people have different heights, it is desirable to provide several attaching points on the wheel to accommodate this expectation. The string is preferably made of strong and durable Nylon.

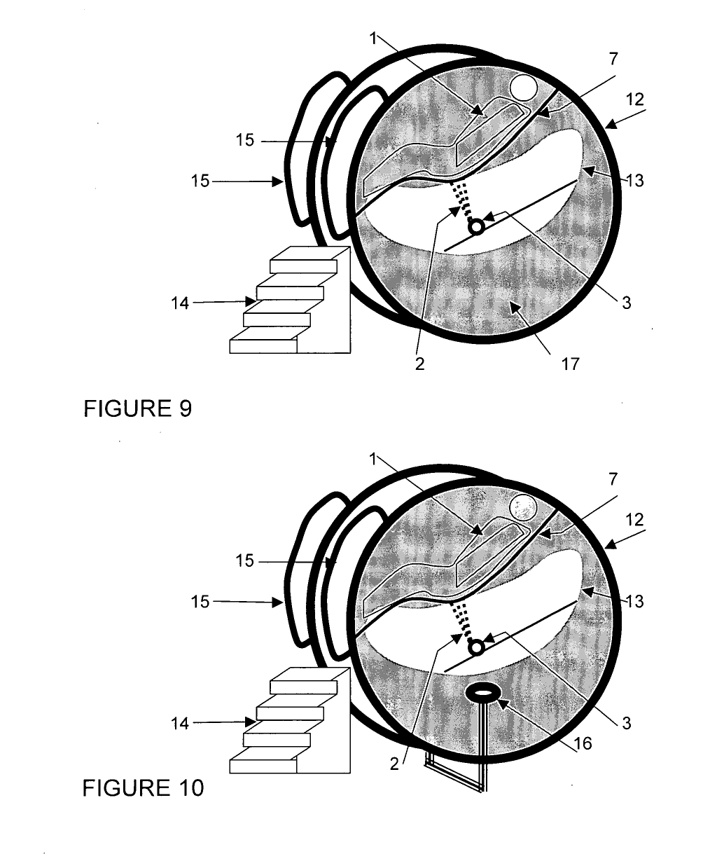

FIG. 9 shows a schematic sketch of the full embodiment of the dry hydro-massage machine including see-through windows 13 (un-shaded area) on the aluminum sides 17 (shaded area), set of stairs 14, and external handrails 15.

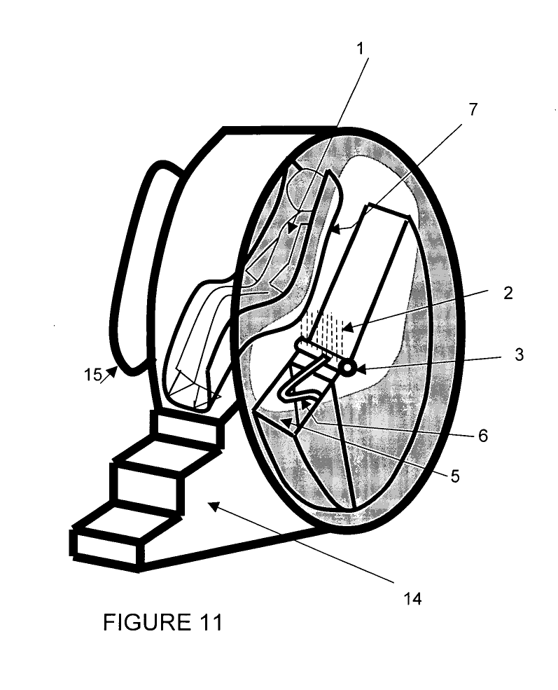

The outer shape is not necessarily round, and could have any desired shape, but the round shape is preferred to allow rolling on the floor to recline the seating chair, this rotation however can be achieved by mounting the whole embodiment on a raised axis 16 as shown in FIG. 10, this axis can be preferably in the centre of the said embodiment, or at any other desired location, This axis is shown however at not exactly the centre of the embodiment for more clarity of the drawing. In this figure the sides of the embodiment 17 that are preferably made of aluminum are also shown.

Finally FIG. 11 shows a perspective view of the main components of the machine to add more clarity to the relation between those elements. One handrail is omitted to avoid crowding the view, while the un-shaded area represents the see-through pane.

The above description is intended to show only an example of how the invention may be embodied, apparently the different components can be assembled in many arrangements and by the use of many different materials, moreover some unclaimed functions could be achieved by many other methods that will not radically alter the broad concept of the invention. All those changes that do not depart from the general concept of the present invention are intended to be included in the claims attached hereto.

I claim:

1) A dry hydro-massage apparatus comprising:
A) A user's weight-bearing apparatus comprising a seating surface of generally loosely held flexible sheet, said sheet supporting substantially the entire backside of the user's body, said sheet is attached at two or more sides to a frame body, said frame body comprising one or more interrelated portions, said portions are interconnected to eventually form a substantially bent backwardly inclined sitting position, said frame body can be reclined to form the said inclined position by an unfolding or a rotating action, said flexible sheet being attached to the said frame body will always follow the shape of the said frame body, allowing the user's body to conform with the said substantially bent backwardly inclined position.
B) A water jetting apparatus positioned under the said loosely held flexible sheet, said water-jetting apparatus having a plurality of nozzles on its surface. A pulsating stream of water is ejected through said nozzles, said pulsating stream of water impacts stresses on the underside of the said sheet, said stresses are transmitted through the said sheet leading to creating a soothing massaging effect on the opposing body parts of the user, said water jetting apparatus to be moved mechanically to alternately impact said stresses on various locations of the user's backside.
C) An obstructing means to obstruct water passage and splashing that could pass between the said frame body and the body enclosing the said water jetting apparatus.
D) Said flexible seating sheet to be of single or composite layers of different materials.

2) A dry hydro-massage apparatus comprising:
A) A weight bearing apparatus that involves the user resting on his backside, and involves a water jetting activity that impact stresses on the user's backside.
B) See-through portions on one ore more sides of the dry hydro-massage apparatus, said see-through portions to be generally below the level of the said weight bearing apparatus, said see-through portions to be looking on the said water jetting activity.
C) The said weight bearing apparatus and the said see-through portions to be at a raised level from the floor, said raised level to allow an average-height adult person standing outside the hydro-massage apparatus to conveniently watch the said ongoing water jetting activity.
D) An ascending-descending apparatus to enable the user to ascend to and descend from the said raised sitting position.

3) A dry hydro-massage apparatus of claim 1 wherein the said water jetting apparatus slides in restrained motion along a horizontal or inclined track, said water-jetting apparatus is attached to a strong non-rusting flexible string, said string is attached on the other end to a slowly rotating motor-driven wheel, said wheel pulls the said string and then releases it as it rotates, consequently the pulling and releasing action happens in an alternating manner, said pulling and releasing action is transferred through one or more pulleys to the end of said string attached to the said water jetting apparatus, causing it to move in one direction when the said string is pulled, and allowing it to reverse its motion due to the force of gravity when the said string is released. The breadth of the movement of the said water jetting apparatus depends on the distance between the point at which the said string is attached on the said wheel and the centre of rotation of the said wheel, said distance is adjustable by varying the location of the point at which the said string is attached to the said wheel.

4) A dry hydro-massage apparatus of claim 3 wherein said water-jetting apparatus is attached to rollers on each side, said rollers to roll on one or more rails, said water-jetting apparatus to be restrained in a manner to control the angle of the direction of the jetting water.

5) A dry hydro-massage apparatus of claim 1 wherein said apparatus includes a water temperature regulating apparatus.

6) A dry hydro-massage apparatus of claim 1 wherein said apparatus includes sounds generating apparatus.

7) A dry hydro-massage apparatus of claim 1 wherein said apparatus includes a visual apparatus

8) A dry hydro-massage apparatus of claim 1 wherein said apparatus having one or more of the sides of the embodiment of said apparatus continuing to a height that is generally higher than the highest point in the user's body whilst in a sitting position, said sides to offer a feeling of privacy to the user.

9) A dry hydro-massage apparatus of claim 1 wherein the said rotating action to recline the said weight-bearing apparatus can be achieved by rotating part of or all the embodiment of the said dry hydro-massage apparatus, said rotation to be about any axis.

10) A dry hydro-massage apparatus of claim 1 wherein said apparatus includes sound insulating means for the noise generating components.

11) A dry hydro-massage apparatus of claim 1 wherein the electrical devices are separated from the adjacent electrically conducting elements by a layer or more of a non-conductive material.

12) A dry hydro-massage apparatus of claim 1 wherein the said apparatus includes a water reservoir, a water circulation arrangement, rigid or flexible pipes, water pumping apparatus, one or more electric motors, and a reducing gear apparatus. All connected where necessary by belts, or any other recognized means in the industry.

13) A dry hydro-massage apparatus of claim 1 wherein said apparatus includes a timer for shutting off the said apparatus

14) A dry hydro-massage apparatus of claim 1 wherein said apparatus includes a short-circuit breaker apparatus

15) A dry hydro-massage apparatus of claim 1 wherein said apparatus be switched on and off by any recognized method including hand operated control apparatus.

16) A dry hydro-massage apparatus of claim 1 wherein the said apparatus includes arms and head supports for the user, said supports can be separate items or integral part of the said water bearing apparatus.

17) A dry hydro-massage apparatus of claim 1 wherein the said apparatus includes a water pressure adjusting apparatus.
